(19) United States
(12) Patent Application Publication
(10) Pub. No.: US 2025/0384692 A1
(43) Pub. Date: Dec. 18, 2025

(54) CONFERENCE IMAGE DISPLAY METHOD AND VIDEO CONFERENCE DEVICE

(71) Applicant: AVer Information Inc., New Taipei City (TW)

(72) Inventors: Sen Chiao CHANG, New Taipei City (TW); Chih Tsung CHIANG, New Taipei City (TW); Hung Jie XIAO, New Taipei City (TW); Wei Chun TSAI, New Taipei City (TW)

(21) Appl. No.: 19/231,586

(22) Filed: Jun. 9, 2025

(30) Foreign Application Priority Data
Jun. 13, 2024 (TW) 113121945

(51) Int. Cl. G06V 20/52; G06F 3/0484; G06V 40/10

(52) U.S. Cl. CPC G06V 20/53; G06F 3/0484; G06V 40/10

(57) ABSTRACT

A conference image display method includes steps as follows. A conference person in the space is detected through a camera; a virtual fence including the conference person is created, and a corresponding image of the conference person is displayed in the conference interface; when a new person entering the space is detected through the camera, it is determined whether the new person meets the joining condition, where the joining condition is associated with the virtual fence; when the new person meets the joining condition, whether the new person is added to a conference is decided based on a control instruction sent by the conference person; when control instruction allows the new person to join the conference, a corresponding image of the new person is added to the conference interface, and the virtual fence is updated to include the new person.

### CROSS-REFERENCE TO RELATED APPLICATION

This application claims priority to Taiwan Application Serial Number 113121945, filed Jun. 13, 2024, which is herein incorporated by reference in its entirety.

### BACKGROUND

### Technical Field

The present disclosure relates to an electronic device and an operation method thereof, and more particularly to a conference image display method and a video conference device.

### Description of Related Art

Nowadays, conference rooms are gradually transitioning to open partitions or transparent partitions. However, in video conferencing, a visual output of the video conferencing is easily disturbed by a person walking by or staying around.

To address issues described above, those skilled in the art are dedicated to find solutions, but no suitable solution has been developed for a long time. Therefore, how to intelligently and automatically distinguish whether a person is joining in the conference is one of the important research subjects at present and a goal that needs to be improved urgently in the current related fields.

### SUMMARY

A conference image display method and a video conference device are provided to improve the issues described above.

In some embodiments of the present disclosure, a conference image display method is provided, in which the method includes steps as follows: detecting at least one conference person in a space through a camera; creating a virtual fence including the at least one conference person, and displaying a corresponding image of the at least one conference person in a conference interface; in response to the camera detecting that a new person enters the space, determining whether the new person meets a joining condition associated with the virtual fence; in response to the new person meeting the joining condition, determining whether to add the new person to a conference based on a control instruction sent by the at least one conference person; in response to the control instruction allowing to add the new person to the conference, adding a corresponding image of the new person to the conference interface, and updating the virtual fence to include the new person.

In some embodiments of the present disclosure, a video conference device provided in the present disclosure includes a camera and a processor, in which the processor is electrically connected to the camera, and the processor is used to: detect at least one conference person in a space through the camera; create a virtual fence including the at least one conference person and provide a conference interface; display a corresponding image of the at least one conference person in the conference interface; in response to the camera detecting a new person enters the space, determine whether the new person meets a joining condition associated with the virtual fence.

In summary, compared with the prior art, a technical solution of the present disclosure has obvious advantages and benefits. Current conference person and a conference interface with intelligent composition are presented in an open conference room by utilizing the conference image display method and the video conference device of the present disclosure. The technical solution of the present disclosure may track the conference person in real-time, and may detect whether the new person joins the conference and prompt the detection result on the conference interface at any time. The display image of the conference interface may not be disturbed by the person that is not related to the conference walking by or staying around.

The above description will be described in detail using embodiments below, and the embodiments are intended to provide further explanation of the technical solution of the present disclosure.

### BRIEF DESCRIPTION OF THE DRAWINGS

The above and other objects, features, advantages and examples of the present disclosure can be more fully understood, with reference made to the accompanying drawings as follows:

FIG. 1 is a flow diagram of a conference image display method in accordance with some examples of the present disclosure.

FIG. 2 is a schematic diagram of a virtual fence in accordance with some examples of the present disclosure.

FIG. 3 is a schematic diagram of a conference interface in accordance with some examples of the present disclosure.

FIG. 4 is a schematic diagram of a virtual fence in accordance with some examples of the present disclosure.

FIG. 5 is a schematic diagram of a conference interface in accordance with some examples of the present disclosure.

FIG. 6 is a schematic diagram of a virtual fence in accordance with some examples of the present disclosure.

FIG. 7 is a block diagram of a video conference device in accordance with some examples of the present disclosure.

### DETAILED DESCRIPTION

In order to make the description of the present disclosure more detailed and complete, reference is made to accompanying drawings and examples of the present disclosure below, and the same numbers used in the drawings refers to the same or like components. On other hands, well-known components and steps are not described in the examples to avoid unnecessary limitations on the present disclosure.

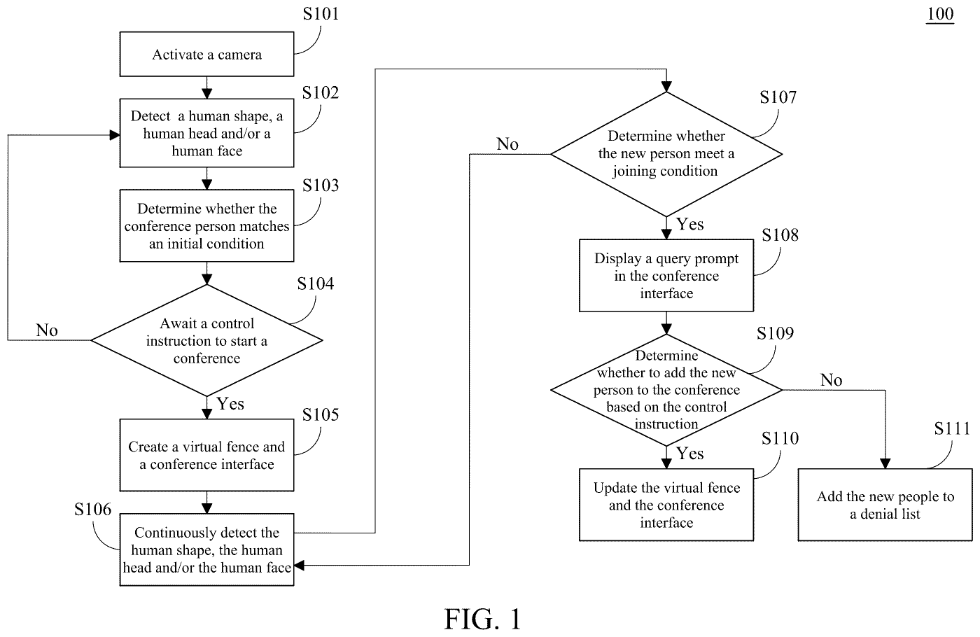

FIG. 1 is a flow diagram of a conference image display method 100 in accordance with some examples of the present disclosure. It should be understood that steps described in FIG. 1, except the orders of which are specifically stated, may be adjusted according to actual needs, and may even be executed simultaneously or partially simultaneously. In practice, for example, the conference image display method 100 may be executed by a video conference device.

In step S101, a camera is activated. In step S102, at least one conference person in a space is detected through the camera. In practice, for example, the conference person in the space is detected based on an object detection of a human shape, a human head and/or a human face.

In step S103, it is determined whether the conference person matches an initial condition. In practice, for example, if the members in the space have consistent predetermined behaviors (for example, a sitting posture, etc.), and continue for a predetermined time, the foregoing members are considered as the conference persons matching the initial condition.

In step S104, a control instruction to start a conference is awaited. In practice, for example, the conference person may input the control instruction to start the conference by a hand gesture (for example, the hand gesture is predetermined to raise a thumb), a voice or a remote controller.

In step S105, a virtual fence including the conference person and a conference interface are created, and a corresponding image of the conference person is displayed in the conference interface.

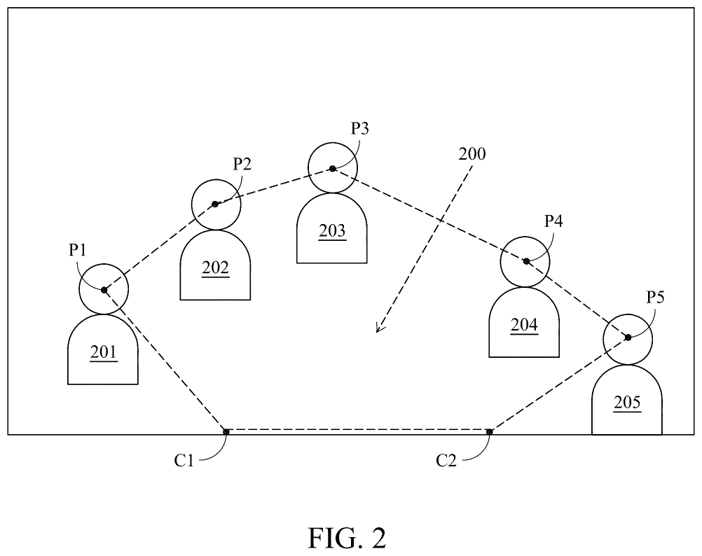

In order to give a clearer depiction of the virtual fence of step S105, reference is made to FIG. 1 and FIG. 2. FIG. 2 is a schematic diagram of a virtual fence 200 in accordance with some examples of the present disclosure. In step S105, an initial point C1 and an initial point C2 (for example, two separated points at a bottom edge of the image) are set in the space detected by the camera. Information points P1-P5 (for example, center points, top points or other feature points of the human shape or the human head) of the conference persons 201-205 in the space are detected. A crowd computing is performed on the information points P1-P5 of the conference persons 201-205 and the initial points C1 and C2 to obtain a range (for example, a polygon range) as the virtual fence 200, in which the virtual fence 200 is used as a basis for subsequently determining whether to add a new person to the conference.

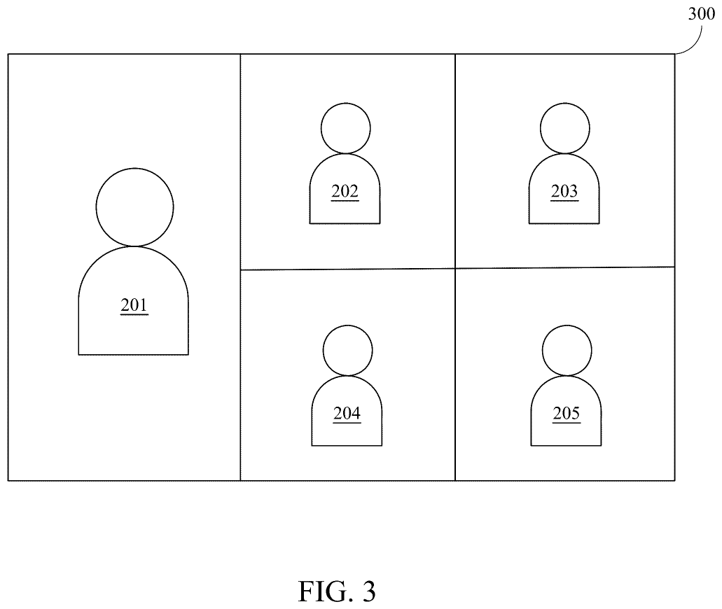

In order to give a clearer depiction of the virtual fence of step S105, reference is made to FIG. 1 and FIG. 3. FIG. 3 is a schematic diagram of a conference interface 300 in accordance with some examples of the present disclosure. In step S105, the conference interface 300 uses an intelligent composition to display the conference persons 201-205.

Next, back to FIG. 1. In step S106, a new person in the space is continuously detected based on the object detection of the human shape, the human head and/or the human face.

In step S107, upon the camera detects that the new person enters the space, it is determined whether the new person meets a joining condition, in which the joining condition is associated with the virtual fence 200.

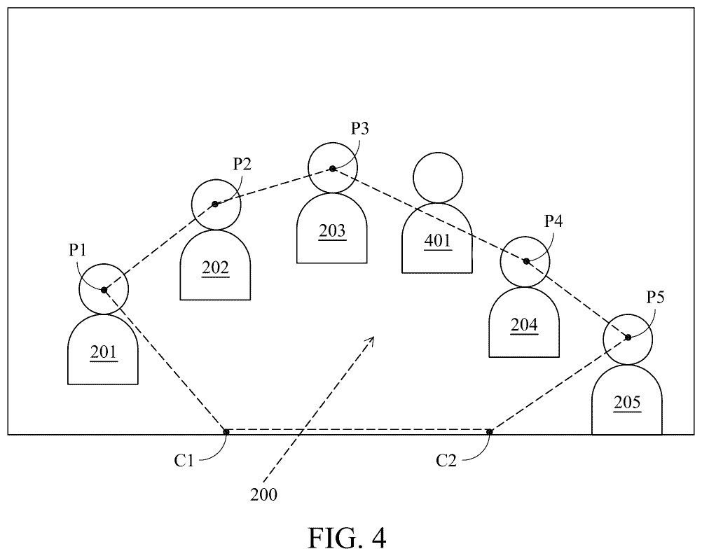

In order to give a clearer depiction of the joining condition of step S107, reference is made to FIG. 1 and FIG. 4. FIG. 4 is a schematic diagram of the virtual fence 200 in accordance with some examples of the present disclosure. In step S107, it is determined whether a human-shaped range of a new person 401 touches the virtual fence 200. Upon the human-shaped range of the new person 401 touches the virtual fence 200, it is determined whether an overlapping ratio of an overlapping area between the human-shaped range of the new person 401 and the virtual fence 200 to the human-shaped range of the new person exceeds a predetermined threshold (for example, the predetermined threshold is about one-twice to one-third). In some examples, upon the overlapping ratio exceeds the predetermined threshold, it is determined that the new person 401 meets the joining condition in step S107. Alternatively or in addition, in some examples, upon the overlapping ratio exceeds the predetermined threshold, it is further determined whether a hold-up time when the overlapping ratio exceeds the predetermined threshold lasts for a predetermined time (for example, the predetermined time is about three seconds to five seconds) in step S107. When the overlapping ratio exceeds the predetermined threshold for the predetermined time or more than the predetermined time, it is determined that the new person 401 meets the joining condition in step S107. Determination accuracy may be improved by the foregoing determination process of step S107.

On the other hand, upon the overlapping ratio described above does not exceed the predetermined threshold, it is determined whether a size ratio of a profile feature (such as, the human shape, the human head, and the human face) of the new person 401 matches a size ratio range calculated based on profile features (such as, the human shape, the human head, and the human face) of the conference persons 201-205 in step S107. In practice, for example, an upper limit value of the size ratio range may be one of the conference persons 201-205 that has a largest profile feature or the one of the conference persons 201-205 that has a largest profile feature multiplied by a predetermined scale factor (for example, the predetermined scale factor is about 1.1 to 1.5). A lower limit value of the size ratio range may be one of the conference persons 201-205 that has a smallest profile feature or the one of the conference persons 201-205 that has a smallest profile feature multiplied by a predetermined scale factor (for example, the predetermined scale factor is about 0.9 to 0.5). If the size ratio of the profile feature of the new person 401 is in the size ratio range described above, it is determined that the size ratio of the profile feature of the new person 401 matches the size ratio range described above in step S107.

As above, in some examples, upon the size ratio of the profile feature of the new person 401 matches the size ratio range described above, it is determined that the new person 401 meets the joining condition in step S107, thus effectively reducing a determination time. Alternatively or in addition, in some examples, upon the size ratio of the profile feature of the new person 401 matches the size ratio range described above, it is further determined whether the size ratio of the profile feature of the new person 401 matches the size ratio range for a predetermined time (for example, the predetermined time is about three seconds to five seconds) in step S107. When the size ratio of the profile feature of the new person 401 matches the size ratio range for the predetermined time, it is determined that the new person 401 meets the joining condition in step S107, thus improving the determination accuracy.

Alternatively, in some examples, it is determined whether the human-shaped range of the new person 401 touches the virtual fence 200 in step S107. Upon the human-shaped range of the new person 401 touches the virtual fence 200, and when the human-shaped range of the new person 401 touches the virtual fence 200 for the predetermined time or more than the predetermined time, it is determined that the new person 401 meets the joining condition in step S107, thus simplifying the determination process.

If the new person 401 meets the joining condition, a query prompt is displayed in the conference interface 300, in which the query prompt is used to guide any one of the conference persons 201-205 to send the control instruction to choose whether to add the new person 401 to the conference in step S108. In practice, for example, any one of the conference persons 201-205 may input the control instruction regarding an allowance or a denial for adding the new person 401 to the conference by the hand gesture, the voice or the remote controller.

In step S109, if the new person 401 meets the joining condition, it is determined whether to add the new person 401 to the conference based on the control instruction sent by the conference person. If the control instruction allows adding the new person 401 to the conference, a corresponding image of the new person 401 is added to the conference interface 300 in step S110, and the virtual fence 200 is updated to include the new person 401.

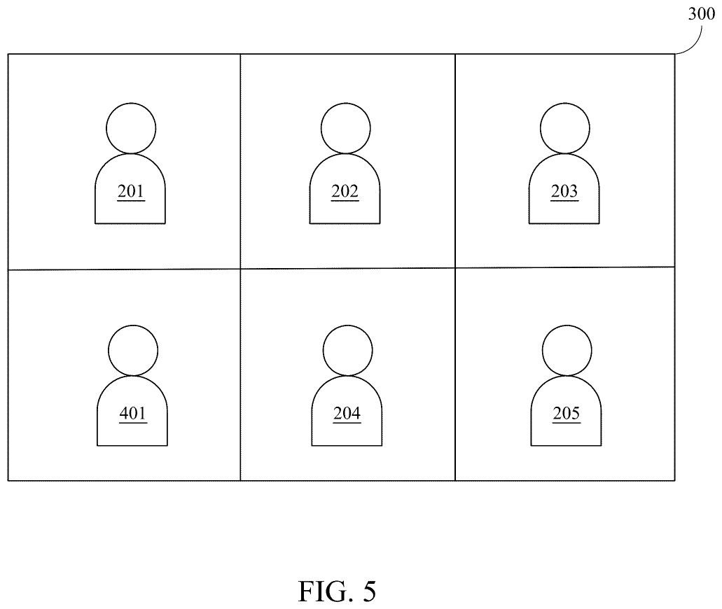

In order to give a clearer depiction of the conference interface 300 of step S110, reference is made to FIG. 1 and FIG. 5. FIG. 5 is a schematic diagram of the conference interface 300 in accordance with some examples of the present disclosure. In step S110, the conference interface 300 uses the intelligent composition to display the conference persons 201-205 and the new person 401.

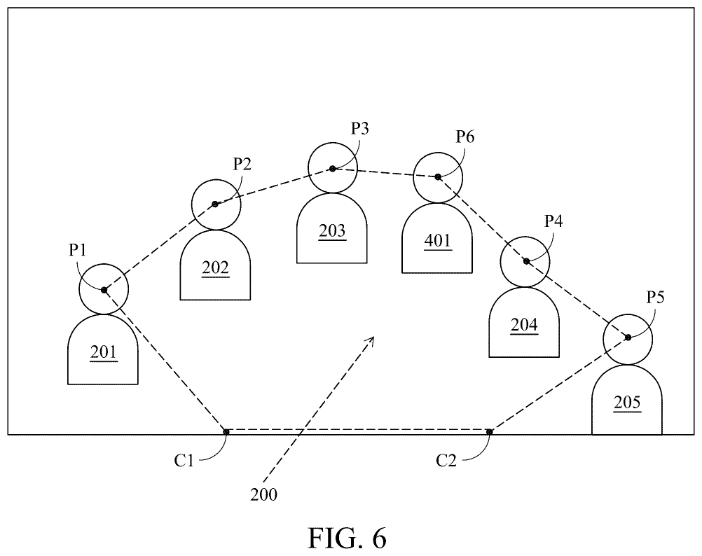

In order to give a clearer depiction of the virtual fence 200 of step S110, reference is made to FIG. 1 and FIG. 6. FIG. 6 is a schematic diagram of the virtual fence 200 in accordance with some examples of the present disclosure. In step S110, an information point P6 of the new person 401 in the space is detected, and a crowd computing is performed on the information points P1-P5 of the conference persons 201-205, the information point P6 of the new person 401 and the initial points C1 and C2 to update the virtual fence 200.

On the other hand, if the control instruction denies the new person 401 from joining to the conference, the new person 401 is added to a denial list in step S111. In practice, for example, if the camera detects that the new person 401 on the denial list enters the space for the second time, the foregoing new person 401 is denied to join the conference.

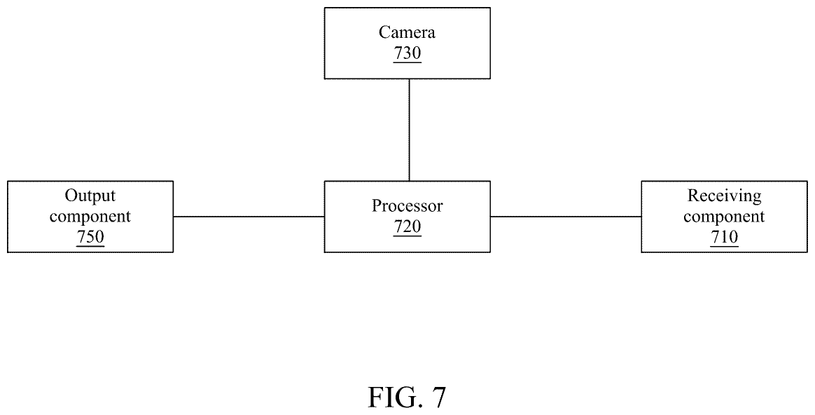

In order to give a clearer depiction of a video conference device executing the conference image display method 100, reference is made to FIG. 1 to FIG. 7. FIG. 7 is a block diagram of a video conference device 700 in accordance with some examples of the present disclosure. As shown in FIG. 7, the video conference device 700 may include a receiving component 710, a processor 720, a camera 730, and an output component 750.

Structurally, the processor 720 is electrically connected to the receiving component 710, the camera 730, and the output component 750. In practice, for example, the receiving component 710 may be a microphone, a remote control signal receiver, a button, and an input device, etc. The processor 720 may be a processing circuit. The camera 730 may be a web camera. The output component 750 may be a network transmission device, a display device, and an image output device, etc.

During the operation, the processor 720 detects the conference persons 201-205 in a space through a camera, the processor 720 creates the virtual fence 200 including the conference persons 201-205, and provides the conference interface 300, the processor 720 displays the corresponding image of conference persons 201-205 in the conference interface 300, and upon the processor 720 detects the new person 401 entering the space through the camera 730, the processor 720 determines whether the new person 401 meets the joining condition associated with the virtual fence 200.

If the new person 401 meets the joining condition, the processor 720 determines that a control instruction received by the receiving component 710 either allows or denies adding the new person 401 to the conference. If the control instruction allows adding the new person 401 to the conference, the processor 720 adds the corresponding image of the new person 401 to the conference interface 300, and updates the virtual fence 200 to include the new person 401.

On the other hand, the processor 720 outputs the conference interface 300 through the output component 750. If the new person 401 meets the joining condition, the processor 720 displays the query prompt in the conference interface 300, in which the query prompt is used to guide any one of the conference persons 201-205 to send the control instruction described above.

In summary, compared with the prior art, a technical solution of the present disclosure has obvious advantages and benefits. Current conference persons 201-205 and the conference interface 300 with the intelligent composition are presented in a conference room with open partitions or transparent partitions by utilizing the conference image display method 100 and the video conference device 700 of the present disclosure. The technical solution of the present disclosure may track the conference persons 201-205 in real-time, and may detect whether the new person 401 joins the conference and prompt the detection result on the conference interface 300 at any time. The display image of the conference interface 300 may not be disturbed by the person that is not related to the conference walking by or staying around.

Although the present disclosure has been described in considerable detail with reference to embodiments thereof, those are not intended to limit the present disclosure. Those skilled in the art can make various modifications and retouches to the structure of the present disclosure without departing from the scope or spirit of the disclosure, and therefore the scope of protection of the present disclosure shall be subject to the scope of the claims attached hereafter.

What is claimed is:

1. A conference image display method, comprising following steps:
(A) detecting at least one conference person in a space through a camera;
(B) creating a virtual fence comprising the at least one conference person, and displaying a corresponding image of the at least one conference person in a conference interface;
(C) in response to the camera detecting that a new person enters the space, determining whether the new person meets a joining condition associated with the virtual fence;
(D) in response to the new person meeting the joining condition, determining whether to add the new person to a conference based on a control instruction sent by the at least one conference person; and
(E) in response to the control instruction allowing adding the new person to the conference, adding a corresponding image of the new person to the conference interface, and updating the virtual fence to comprise the new person.

2. The conference image display method of claim 1, wherein the step (B) comprises:
setting at least one initial point in the space detected by the camera;
detecting an information point of the at least one conference person in the space; and
performing a crowd computing on the information point of the at least one conference person and the at least one initial point to obtain a range as the virtual fence, wherein the virtual fence is used as a basis for determining whether to add the new person to the conference.

3. The conference image display method of claim 2, wherein the step (E) comprises:
detecting an information point of the new person in the space; and
performing a crowd computing on the information point of the at least one conference person, the information point of the new person, and the at least one initial point to update the virtual fence.

4. The conference image display method of claim 1, wherein the step (C) comprises:
determining whether a human-shaped range of the new person touches the virtual fence;
in response to the human-shaped range of the new person touching the virtual fence, determining whether an overlapping ratio of an overlapping area between the human-shaped range of the new person and the virtual fence to the human-shaped range of the new person exceeds a predetermined threshold;
in response to the overlapping ratio exceeding the predetermined threshold, determining whether the overlapping ratio exceeds the predetermined threshold for a predetermined time; and
in response to the overlapping ratio exceeding the predetermined threshold for the predetermined time, determining that the new person meets the joining condition.

5. The conference image display method of claim 4, wherein the step (C) further comprises:
in response to the overlapping ratio not exceeding the predetermined threshold, determining whether a size ratio of a profile feature of the new person matches a size ratio range calculated based on a profile feature of the at least one conference person;
in response to the size ratio of the profile feature of the new person matching the size ratio range, determining whether the size ratio of the profile feature of the new person matching the size ratio range for the predetermined time; and
in response to the size ratio of the profile feature of the new person matching the size ratio range for the predetermined time, determining that the new person meets the joining condition.

6. The conference image display method of claim 1, wherein the step (D) comprises:
in response to the new person meeting the joining condition, a query prompt is displayed in the conference interface, wherein the query prompt is configured to guide the at least one conference person to send the control instruction.

7. The conference image display method of claim 1, further comprising:
in response to the control instruction denying the new person from joining the conference, the new person is added to a denial list.

8. A video conference device, comprising
a camera; and
a processor electrically connected to the camera, wherein the processor is configured to:
detect at least one conference person in a space through the camera;
create a virtual fence comprising the at least one conference person and provide a conference interface;
display a corresponding image of the at least one conference person in the conference interface; and
in response to the camera detecting a new person enters the space, determine whether the new person meets a joining condition associated with the virtual fence.

9. The video conference device of claim 8, further comprising:
a receiving component electrically connected to the processor, wherein the processor is further configured to:
in response to the new person meeting the joining condition, determine whether a control instruction received by the receiving component allows or denies adding the new person to a conference; and
in response to the control instruction allowing to add the new person to the conference, add a corresponding image of the new person to the conference interface, and update the virtual fence to comprise the new person.

10. The video conference device of claim 9, further comprising:
an output component electrically connected to the processor, wherein the processor is further configured to:
output the conference interface through the output component; and
in response to the new person meeting the joining condition, display a query prompt in the conference interface, wherein the query prompt is configured to guide the at least one conference person to send the control instruction.

11. The video conference device of claim 8, wherein the processor is further configured to:
determine whether a size ratio of a profile feature of the new person matches a size ratio range calculated based on a profile feature of the at least one conference person.

12. The video conference device of claim 11, wherein an upper limit value of the size ratio range is one of the at least one conference person that has a largest profile feature or the one of the at least one conference person multiplied by a first predetermined scale factor.

13. The video conference device of claim 12, wherein the first predetermined scale factor is about 1.1 to 1.5.

14. The video conference device of claim 11, wherein a lower limit value of the size ratio range may be one of the at least one conference person that has a smallest profile feature or the one of the at least one conference person multiplied by a second predetermined scale factor.

15. The video conference device of claim 14, wherein the second predetermined scale factor is about 0.5 to 0.9.
